(19) United States
(12) Patent Application Publication
(10) Pub. No.: US 2008/0073052 A1
(43) Pub. Date: Mar. 27, 2008

(54) Paper Transporting Felt for Shoe Press, and Press Apparatus of Shoe Press Type Paper Machine having the Paper Transporting Felt

(75) Inventor: Yasuhiko Kobayashi, Tokyo (JP)

Correspondence Address: MORGAN LEWIS & BOCKIUS LLP, 1111 PENNSYLVANIA AVENUE NW, WASHINGTON, DC, 20004, US

(73) Assignee: ICHIKAWA CO., LTD., Bunkyo-ku, Tokyo (JP)

(21) Appl. No.: 11/659,495

(22) PCT Filed: Jul. 29, 2005
(86) PCT No.: PCT/JP05/14371

§ 371 Date: Feb. 6, 2007

(30) Foreign Application Priority Data
Aug. 10, 2004 (JP) 2004-233095

(51) Int. Cl. D21F 3/02; B32B 5/02

(52) U.S. Cl. 162/358.2; 442/326

(57) ABSTRACT

A paper transporting felt for a shoe press includes a base layer, a first batt layer which is formed on a wet paper side surface of the base layer, a second batt layer which is formed on a roll side surface or a shoe side surface of the base layer, and a wet paper contacting fibrous layer which includes split fibers and is formed on a wet paper side surface of the first batt layer so as to come into direct contact with the wet paper. The split fibers are split by being pressurized by the roll and the shoe.

### TECHNICAL FIELD

The present invention relates to a wet paper transporting felt for a shoe press (hereafter referred to as the “paper transporting felt for a shoe press” or simply as the “paper transporting felt”) and a press apparatus of a shoe press type paper machine having the paper transporting felt.

### BACKGROUND ART

A press part of a shoe press type paper machine is provided with a press apparatus. The press apparatus has a plurality of press mechanisms disposed in series along a transporting direction of a wet paper. Each press mechanism has a pair of endless belt-shaped paper transporting felts as well as a roll and a shoe (i.e., a shoe press) which are disposed in such a manner as to vertically oppose each other to nip respective portions of the paper transporting felts therebetween. As the wet paper being transported by the paper transporting felts which travel at substantially the same speed in the same direction is pressurized by the roll and the shoe together with the paper transporting felts, water in the wet paper is absorbed by the paper transporting felts while being squeezed (i.e., dewatered) from the wet paper.

According to the press mechanism having the above-described shoe press, in comparison with a press mechanism having a more popular roll press (i.e., not a combination of the roll and the shoe, but a press mechanism using a pair of rolls), the press zone of a pressing portion (i.e., a nip) formed by the roll and the shoe can be made wider. Since the pressing time can be made long, the dewatering efficiency excels further.

However, at a portion extending from a center of the pressing portion between the roll and the shoe to an exit, the pressure applied to the wet paper and the paper transporting felts is suddenly released, the volumes of the paper transporting felts and the wet paper suddenly expand in this portion. As a result, negative pressure occurs in the paper transporting felts and the wet paper, and since the wet paper consists of fine fibers, the capillary phenomenon is further added. Therefore, the so-called re-wetting phenomenon occurs in which the water absorbed in the paper transporting felts is moved back to the wet paper. Thus, the portion extending from the center of the pressing portion between the roll and the shoe to the exit constitutes a major factor causing the dewatering performance of the press apparatus of the shoe press type paper machine to decline.

A press felt for papermaking is known in which the occurrence of the re-wetting phenomenon is suppressed by disposing a hydrophilic nonwoven fabric in a batt layer so as to improve the dewatering performance (e.g., refer to JP-A-2004-143627). As examples of the hydrophilic nonwoven fabric, it is possible to cite nonwoven fabrics formed by laminating fibers obtained by melting a resin and by forming it into yarn, e.g., spunbonded nonwoven fabrics obtained by laminating continuous filaments, nonwoven fabrics obtained by drawing a molten polymer by hot air into ultra-fine fibers and forming them into sheet form, and so on.

Since the hydrophilic nonwoven fabric is higher in density and lower in water permeability than the batt fibers, the water in the batt layer disposed closer to the roll side (or the shoe side) than the hydrophilic nonwoven fabric in the press felt for papermaking is difficult to permeate through the hydrophilic nonwoven fabric and move to the wet paper side batt layer and the wet paper. Accordingly, the return of water in the batt fibers in the roll-side (or the shoe-side) batt layer to the wet paper is suppressed by this hydrophilic nonwoven fabric. In addition, since the size of the fibers of the hydrophilic nonwoven fabric is smaller than the size of the fibers of the batt layer, the water in the batt layer disposed closer to the wet paper side than the hydrophilic nonwoven fabric easily moves to the hydrophilic nonwoven fabric owing to the capillary phenomenon, thereby preventing the re-wetting phenomenon.

With the press apparatus of the shoe press type paper machine, in comparison with a press apparatus using a roll press, water is squeezed out by applying a very large pressure to the paper transporting felts at the pressing portion (i.e., the nip), so that stains (specifically, components of such as additives and paste contained in the wet paper) are likely to attach to the paper transporting felts. Accordingly, with the press apparatus of the shoe press type paper machine, since the life of the paper transporting felt (i.e., the usable period of the paper transporting felt) is short, maintenance is required to replace the paper transporting felt with a new one whenever necessary.

Moreover, with the press apparatus of the shoe press type paper machine, the falling off and cutting off of fibers (the so-called loss of fibers) on the surface of the batt layer of the paper transporting felt which comes into direct contact with the wet paper occur noticeably due to the very large pressure or friction at the pressing portion (i.e., the nip). Most of the fallen-off fibers and the cut-off fibers are discharged to the outside of the press apparatus by a cleaning means consisting of a water shower, a suction box, and the like. However, there are cases where slight portions of them are attached to the surface of the wet paper. Since the fallen-off fibers and the cut-off fibers are thicker and harder than the fibers of the wet paper, the paper which has been manufactured with such fibers attached to its surface is inferior in printability in some cases (more specifically, decoloration or the like can occur when printing is effected). Thus, the loss of fibers on the batt layer surface of the paper transporting felt which comes into direct contact with the wet paper deteriorates the quality of paper products such as printed matter. Meanwhile, the surface of the batt layer constitutes a factor causing the surface smoothness of the wet paper to decline noticeably since the surface becomes coarse due to the loss of fibers.

As principal functions required for the paper transporting felt for the shoe press, not only the wet paper transporting function and the dewatering function but the function of smoothing the wet paper surface is also required, as is apparent from the foregoing description. The paper transporting felt for a shoe press disclosed in JP-A-2004-143627 mainly places priority on the improvement of the dewatering performance, and makes no contribution to the improvement of the smoothness of the wet paper surface required in the manufacture of high-quality paper.

### DISCLOSURE OF THE INVENTION

An object of the invention is to provide a paper transporting felt for a shoe press in which stains can be easily removed and the function of smoothing the wet paper surface is enhanced, as well as a press apparatus of a shoe press type paper machine having the paper transporting felt.

The invention provides a paper transporting felt for a shoe press which is at least one paper transporting felt of a pair of paper transporting felts for a shoe press, which are disposed in a press apparatus provided in a press part of a shoe press type paper machine, form a press mechanism together with a shoe press having a roll and a shoe in the press apparatus, and are pressurized by the roll and the shoe while sandwiching a wet paper, to absorb water squeezed from the wet paper, having:

a base layer;

a first batt layer which is formed on a wet paper side surface of the base layer;

a second batt layer which is formed on a roll side surface or a shoe side surface of the base layer; and

a wet paper contacting fibrous layer which includes split fibers and is formed on a wet paper side surface of the first batt layer so as to come into direct contact with the wet paper,
wherein the split fibers are split by being pressurized by the roll and the shoe.

In the paper transporting felt for a shoe press, the wet paper contacting fibrous layer is formed by mixed-spun fibers containing 15 wt. % to 100 wt. % of the split fibers and the remainder consisting of nonsplit fibers.

The paper transporting felt for a shoe press further has: a hydrophilic nonwoven fabric layer disposed between the base layer and the wet paper contacting fibrous layer.

In the paper transporting felt for a shoe press, each size of the split fibers prior to splitting is 3.3 dtex or smaller.

In the paper transporting felt for a shoe press, each size of the split fibers prior to splitting is 1.9 dtex.

The invention also provides a press apparatus of a shoe press type paper machine having the paper transporting felt for a shoe press.

The invention also provides a press apparatus of a shoe press type paper machine having a plurality of press mechanisms each having the paper transporting felt for a shoe press, wherein the plurality of press mechanisms are disposed in series along a transporting direction of the wet paper transported by the paper transporting felts.

In the press apparatus of a shoe press type paper machine, the paper transporting felt for a shoe press having the hydrophilic nonwoven fabric layer is disposed in the press mechanism disposed on a downstream side in the transporting direction among the plurality of press mechanisms.

In the press apparatus, each size of the split fibers prior to splitting is 3.3 dtex or smaller.

In the press apparatus, each size of the split fibers prior to splitting is 1.9 dtex.

The press apparatus of a shoe press type paper machine is a press machine of a closed draw type.

According to the paper transporting felt for a shoe press, the wet paper contacting fibrous layer including the split fibers, which are formed into finer fibers by being split as the split fibers are pressurized by the shoe press (i.e., the roll and the shoe), is formed on the wet paper side surface of the first batt layer of the paper transporting felt so as to come into direct contact with the wet paper. Therefore, if the wet paper contacting fibrous layer is formed which includes the split fibers, which are formed into fine fibers of extremely small sizes by being split, it is possible to improve the surface smoothness of the wet paper. Moreover, stains (specifically, components of such as additives and paste contained in the wet paper) which are temporarily attached to the paper transporting felts fall off the paper transporting felts together with the fine fibers owing to the so-called phenomenon of loss of fibers of the fine fibers formed by the splitting of the split fibers, and slight portions of them move to the wet paper. Therefore, the stains are difficult to remain on the paper transporting felt. At the time of this movement of stains, even if the fine fibers (i.e., the fine fibers formed by the splitting of the split fibers) which fell off or cut off from the wet paper contacting fibrous layer are more or less attached to the surface of the wet paper, the quality of the wet paper is not caused to decline since the fine fibers are extremely small. Moreover, since the stains which are moved to the wet paper are originally contained in the wet paper as its components, no effect is exerted on the quality of the wet paper. Accordingly, as for the paper manufactured by the shoe press type paper machine using this paper transporting felt for a shoe press, its surface becomes extremely smooth. Moreover, since the life of the paper transporting felt (i.e., the usable period of the paper transporting felt) is long, it is possible to decrease the frequency of maintenance for replacing the paper transporting felt with a new one. Accordingly, it is desirable that the split fibers be included in at least the surface of the wet paper contacting fibrous layer which comes into direct contact with the wet paper.

It should be noted that it goes without saying that the splitting of the split fibers of the wet paper contacting fibrous layer of the paper transporting felt for a shoe press in accordance with the invention is preferably effected at the time of the trial operation (i.e., the so-called running-in operation) of the press apparatus of a shoe press type paper machine. The split fibers used in the paper transporting felt for a shoe press in accordance with the invention are preferably fibers which are split by being pressurized by the shoe press. The split fibers are not split in the carding process and the needling process which are the processes of manufacturing the paper transporting felt, and the split fibers maintain a relatively thick state. For example, if split fibers which are split into fine fibers at the time of carding are subjected to carding, fiber masses (i.e., masses of fibers) are likely to be produced. These fiber masses are implanted in the felt in the needling process, and form irregularities on the surface of the paper transporting felt, so that the surface smoothness of the wet paper declines. Accordingly, such a drawback can be overcome by using the wet paper contacting fibrous layer including the split fibers which are formed into finer fibers by being split as the split fibers are pressurized by the shoe press.

In addition, according to the paper transporting felt for a shoe press, the wet paper contacting fibrous layer is formed by mixed-spun fibers containing 15 wt. % to 100 wt. % of the split fibers and the remainder consisting of nonsplit fibers. Therefore, it is possible to change the characteristics of the paper transporting felt for a shoe press by appropriately changing the mix spinning ratio. Here, the weight ratio in mix spinning is defined by “weight of the split fibers 15A/(weight of the split fibers 15A+weight of the nonsplit fibers)×100.” It should be noted that the nonsplit fibers refer to ordinary monofilaments which are not split even in the carding process or the needling process or even by the pressurization by the shoe press (i.e., the roll and the shoe).

The surface smoothness and the dewatering characteristic, which are the characteristics required for the paper transporting felt for a shoe press, are in an inversely proportional relationship. Hence, if the density of the paper transporting felt for a shoe press is increased to improve the performance of smoothing the surface of the wet paper, the dewatering characteristic tends to deteriorate. Meanwhile, the plurality of press mechanisms disposed from the upstream side in the transporting direction of the wet paper being transported to the downstream side respectively require subtly different functions. Priority is placed on the dewatering characteristic in the case of the paper transporting felt of the press mechanism disposed on the upstream side, while the performance of smoothing the surface of the wet paper is required for the paper transporting felt of the press mechanism disposed on the downstream side. Accordingly, by appropriately changing the mix spinning ratio between the nonsplit fibers and the split fibers, the paper transporting felts can be provided with optimal characteristics (surface smoothing characteristic, dewatering characteristic, etc.) for the respective press mechanisms.

According to the paper transporting felt for a shoe press, since the hydrophilic nonwoven fabric layer is disposed between the base layer and the wet paper contacting fibrous layer, the movement of the water temporarily absorbed from the wet paper by the paper transporting felt back to the wet paper (i.e., the so-called re-wetting phenomenon) is prevented by the hydrophilic nonwoven fabric layer.

According to the paper transporting felt for a shoe press, since the size of each of the split fibers prior to splitting is 3.3 dtex or smaller, even if the size of the split fiber prior to splitting was 3.3 dtex, the size of the fine fibers formed by the splitting of the split fibers becomes smaller than 3.3 dtex. Thus, if the wet paper contacting fibrous layer including the slit fibers, which become fine fibers of a size which is practically as close to the size of the fibers of the wet paper as possible by being split, is formed, it is possible to manufacture high-quality paper extremely excelling in the surface smoothness.

In addition, according to the paper transporting felt for a shoe press, since the size of each of the split fibers prior to splitting is 1.9 dtex, it is more preferable. It should be noted that, as for the nonsplit fibers, those having a size of, for example, 1.9 dtex (the same value as the size prior to splitting of the split fibers) to 6 dtex are preferable.

According to the press apparatus of a shoe press type paper machine, since it has the paper transporting felt for a shoe press, excellent operation and effects are exhibited, as described above.

As in the press apparatus of a shoe press type paper machine, if the press apparatus of a shoe press type paper machine has a plurality of press mechanisms each having the paper transporting felt for a shoe press, and if the plurality of press mechanisms are disposed in series along the transporting direction of the wet paper being transported by the paper transporting felts, it is particularly suitable in effectively squeezing water from the wet paper. Namely, according to the press apparatus of a shoe press type paper machine, a large amount of water can be effectively squeezed from the wet paper containing a large amount of water, with the result that high-speed papermaking operation becomes possible.

Moreover, as in the press apparatus of a shoe press type paper machine, if the paper transporting felt for a shoe press having the hydrophilic nonwoven fabric layer is disposed in the press mechanism disposed on the downstream side in the transporting direction of the wet paper among the plurality of press mechanisms, it is conceivable that the water permeability may slightly decline as compared with the paper transporting felt which does not have the hydrophilic nonwoven fabric layer. However, since the paper transporting felt having the hydrophilic nonwoven fabric layer has not only a function of smoothing the wet paper surface but also a high re-wetting preventing function, this configuration is particularly suitable in preventing the re-wetting phenomenon and suitable in smoothing the wet paper surface.

According to the press apparatus of a shoe press type paper machine, since the size of each of the split fibers prior to splitting is 3.3 dtex or smaller, even if the size of the split fiber prior to splitting was 3.3 dtex, the size of the fine fibers formed by the splitting of the split fibers becomes smaller than 3.3 dtex. Thus, if the wet paper contacting fibrous layer including the slit fibers, which become fine fibers of a size which is practically as close to the size of the fibers of the wet paper as possible by being split, is formed, it is possible to manufacture high-quality paper extremely excelling in the surface smoothness.

In addition, according to the press apparatus of a shoe press type paper machine, since the size of each of the split fibers prior to splitting is 1.9 dtex, it is more preferable.

According to the press apparatus of a shoe press type paper machine, since it is a press apparatus of a closed draw type, the wet paper is transported in a state of being sandwiched by the pair of paper transporting felts for a shoe press. Consequently, the wet paper can be transported at an extremely high speed without applying a force to the wet paper which has weak strength and is likely to be cut off. Accordingly, efficient papermaking is made possible.

Consequently, it is possible to provide a paper transporting felt for a shoe press in which stains can be easily removed and the function of smoothing the wet paper surface is enhanced, as well as a press apparatus of a shoe press type paper machine having the paper transporting felt.

A brief description of the invention has been given above. Further, the details of the invention will be come more apparent by perusing the best mode for carrying out the invention described below, by referring to the appended drawings.

### BRIEF DESCRIPTION OF THE DRAWING

FIG. 1 is a vertical cross-sectional view of a first embodiment of a paper transporting felt for a shoe press in accordance with the invention;

FIG. 2 is a vertical cross-sectional view of a second embodiment of a paper transporting felt for a shoe press in accordance with the invention;

FIG. 3 is an enlarged cross-sectional view of a split fiber for forming a wet paper contacting fibrous layer of the paper transporting felt shown in FIGS. 1 and 2; and

FIG. 4 is a plan view illustrating a schematic construction of an embodiment of a press apparatus of a shoe press type paper machine in accordance with the invention.

### BEST MODE FOR CARRYING OUT THE INVENTION

Hereafter, a detailed description will be given of embodiments of the invention in accordance with the invention with reference to the drawings.

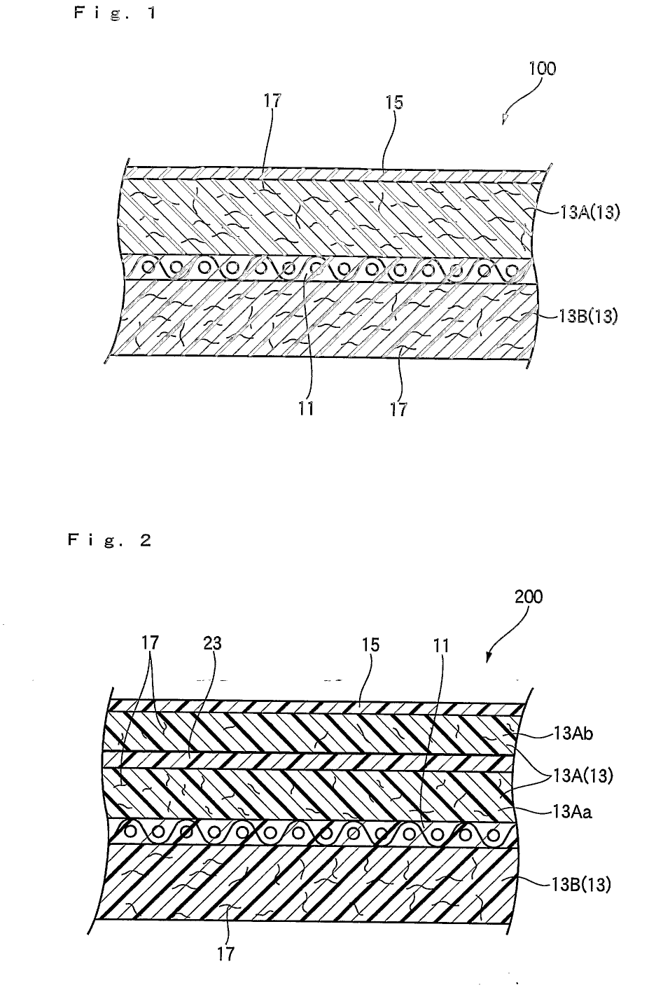

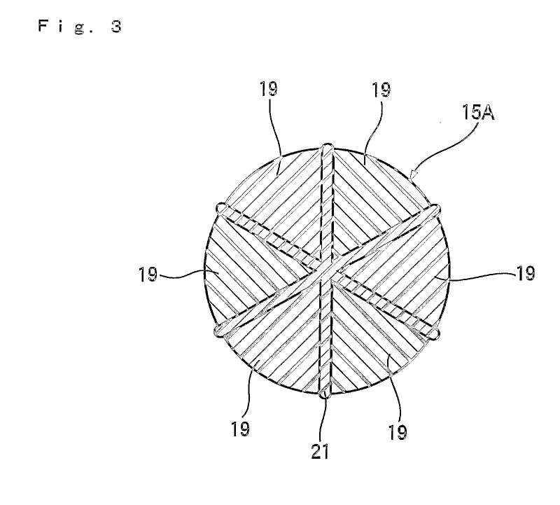

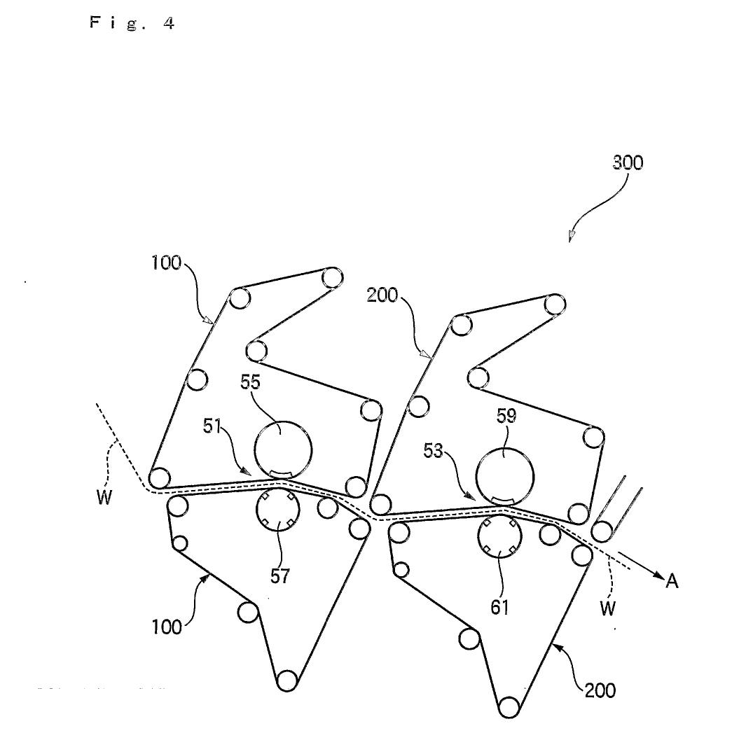

FIG. 1 is a vertical cross-sectional view of a first embodiment of a paper transporting felt for a shoe press (paper transporting felt 100 for a shoe press) in accordance with the invention. FIG. 2 is a vertical cross-sectional view of a second embodiment of a paper transporting felt for a shoe press (paper transporting felt 200 for a shoe press) in accordance with the invention. FIG. 3 is an enlarged cross-sectional view of a split fiber for forming a wet paper contacting fibrous layer of the paper transporting felt for a shoe press shown in FIGS. 1 and 2. FIG. 4 is a plan view illustrating a schematic construction of an embodiment of a press apparatus of a shoe press type paper machine in accordance with the invention.

### First Embodiment

As shown in FIG. 1, the paper transporting felt 100 for a shoe press has a base layer 11, a batt layer 13 (a first batt layer 13A and a second batt layer 13B), and a wet paper contacting fibrous layer 15. More specifically, the first batt layer 13A is formed on the wet paper side surface of the base layer 11, the second batt layer 13B is formed on the roll side surface or the shoe side surface of the base layer 11, and the wet paper contacting fibrous layer 15 is formed on the wet paper side surface of the first batt layer 13A so as to come into direct contact with a wet paper. The base layer 11, the bat layer 13 (the first batt layer 13A and the second batt layer 13B), and the wet paper contacting fibrous layer 15 are entangled and integrated by needling.

The base layer 11 is for imparting strength to the paper transporting felt 100 for a shoe press, and it is possible to appropriately use, for instance, woven fabrics using as basic materials those synthetic fibers such as Nylon 6 and Nylon 66 or natural fibers such as wool that excel in such as wear resistance, fatigue resistance, elongation characteristics, or fabrics formed by overlapping yarns without weaving them or those which have been formed into films by using such materials. In this embodiment, a woven fabric is adopted as the base layer 11. The basis weight of the base layer 11 is 550 g/m², the thickness of the base layer 11 is 1.5 mm, and the density of the fibers forming the base layer 11 is 0.367 g/cm³.

The batt layer 13 (the first batt layer 13A and the second batt layer 13B) is a nonsplit fiber layer formed by staple fibers 17 having a size of 6 decitex (dtex) or greater (generally, 17 dtex or thereabouts). The basis weight of the batt layer 13 is 500 g/m². More specifically, the basis weight of the first batt layer 13A is 400 g/m², and the basis weight of the second batt layer 13B is 100 g/m². The thickness of the first batt layer 13A is 0.9 mm, and the density of the staple fibers 17 forming the first batt layer 13A is 0.444 g/m³. The thickness of the second batt layer 13B is 0.4 mm, and the density of the staple fibers 17 forming the second batt layer 13B is 0.250 g/m³. As the material for forming the batt layer 13, a material similar to that of the base layer 11 is appropriately used. It should be noted that the second batt layer 13B may be omitted in accordance with the characteristics required for the paper transporting felt 100.

The wet paper contacting fibrous layer 15 consists of split fibers 15A (i.e., the split fibers 15A account for 100 wt. % of the wet paper contacting fibrous layer 15). As shown in FIG. 3, each of the split fibers 15A forming the wet paper contacting fibrous layer 15 is a composite fiber having a structure in which it is split into a plurality of fine fibers (petal portions 19 and a stem portion 21 which will be described later) by the pressing action of a press apparatus of a shoe press type paper machine. Split fibers 15A having a size of 3.3 dtex or smaller are preferable, and fibers with circular sections having a size of 1.9 dtex and a length of 51 mm are used in this embodiment. The split fiber 15A consists of seven portions including the six petal portions 19 with sector-shaped sections and one stem portion 21 with a substantially asterisk-shaped section for joining adjacent ones of the petal portions 19. These portions are combined in a circular section and are formed in a splittable manner. In terms of its material, the split fiber 15A is formed of, for instance, Nylon 6 (i.e., N6), and the stem portion 21 is formed of, for instance, polybutylene terephthalate (i.e., PBT). As a specific example of such a split fiber 15A, it is possible to cite ‘PA31’ (tradename; manufactured by Toray Industries, Inc.) or the like. I should be noted that the reason the size of the split fiber 15A is set to 3.3 dtex or smaller is mainly to facilitate the formation of the wet paper contacting fibrous layer 15, and specifically to allow the split fibers 15A to be effectively split by the pressing action of the shoe press (the roll and the shoe) when the paper transporting felt 100 is installed in the press apparatus of the shoe press type paper machine with the split fibers 15A remaining unsplit in a carding process and a needling process, which are the manufacturing processes of the paper transporting felt 100. The basis weight of the wet paper contacting fibrous layer 15 is 250 g/m², the thickness of the wet paper contacting fibrous layer 15 is 0.5 mm, and the density of the split fibers 15 forming the wet paper contacting fibrous layer 15 is 0.500 g/m³. A detailed description will be given of the splitting of the split fibers 15A. It should be noted that the wet paper contacting fibrous layer 15 may be formed by mixed-spun fibers containing 15 wt. % to 100 wt. % of the split fibers 15A and the remainder consisting of nonsplit fibers. The nonsplit fibers are monofilaments which are not split even in the carding process or the needling process or even by the pressurization by the shoe press (i.e., the roll and the shoe). In addition, as the nonsplit fibers, stable fibers having a size of, for instance, 1.9 dtex (i.e., the same value as the size persisting prior to splitting of the split fiber) to 6 dtex are preferable.

A brief description will be given of the method of manufacturing the paper transporting felt 100. First, a sheet in which the batt layer 13 has been integrated on both surfaces of the woven base layer 11 by needling and the like is prepared. Then, after a paper sheet of the split fibers 15A after carding is placed on the surface of the first batt layer 13A, the paper sheet of the split fibers 15A, the batt layer 13, and the base layer 11 are entangled and integrated by needling therethrough so that the wet paper contacting fibrous layer 15 will be formed. The needle used in needling is one which, for example, has a size of 36 gauge, the number of barbs being 6 barbs on 2 edges, the depth of the barbs being approx. 0.1 mm, and the size of the tip of the needle being approx. 0.04 mm in diameter. By using these needles, needling was effected by setting the needle depth to 7 to 16 mm, the number of needling being 650 pcs/cm².

At the time of the carding process, since the split fiber 15A is able to maintain its size of 1.9 dtex, it is possible to prevent the occurrence of a fiber mass produced when carding is effected in a state in which the split fiber 15A is split into fine fibers (the petal portions 19 and the stem portion 21). In addition, in the needling process as well, since both the size of the needle tip (approx. 0.04 mm in diameter) and the depth of the barbs (approx. 0.1 mm) are sufficiently large with respect to the split fibers 15A having a diameter of approx. 0.015 mm (a value calculated from the size of 1.9 dtex) (in other words, since the split fibers 15A are extremely slender), the split fibers 15A move in such a manner as to escape from the needle point during needle piercing in the needling process, so that the needle practically does not pierce the split fibers 15A. In addition, the split fiber 15A which comes into contact with the barb enters the barb which is sufficiently large relative to the size of the split fiber 15A, so that the split fiber 15A is practically not split by the barb. Accordingly, the wet paper contacting fibrous layer 15 (i.e., the split fibers 15A) is not split even by needling, with the result that it is possible to obtain the wet paper contacting fibrous layer 15 having a smooth surface with its major portion remaining in a thick state (1.9 dtex).

The basis weight of the paper transporting felt 100 thus manufactured is 1300 g/m², the thickness of the paper transporting felt 100 is 3.3 mm, and the density of the entire fibers forming the paper transporting felt 100 is 0.394 g/m³. It should be noted that, in the paper transporting felt 100, the density of the entire fibers in the plurality of layers excluding the wet paper contacting fibrous layer 15 is 0.375 g/m³ (the basis weight is 1050 g/m²). The air permeability of this paper transporting felt 100 is 14.4 cc/cm²/sec (this value is a mean value of the values measured by applying a pressure of 125 Pa to test pieces of the paper transporting felt 100 in accordance with the Frazir method on the basis of JIS L 1096).

When the wet paper contacting fibrous layer 15 is caused to travel by being installed in the press apparatus of the shoe press type paper machine, the wet paper contacting fibrous layer 15 is split into a plurality of fine fibers (the petal portions 19 and the stem portion 21) by the pressing action of the roll and the shoe (shoe press). As a result, the paper transporting felt 100 is formed which has the wet paper contacting fibrous layer 15 covered with the fine fibers and provided with a smooth surface. It should be noted that the splitting of the split fibers 15A forming the wet paper contacting fibrous layer 15 is performed in advance during the trial operation (i.e., the so-called running-in operation) of the press apparatus of the shoe press type paper machine by spraying water onto the paper transporting felt 100 by a shower (i.e., a cleaning means) and by pressurizing the paper transporting felt 100 by the roll and the shoe (shoe press) while sucking the water soaked in the paper transporting felt 100 by a suction box (i.e., the cleaning means). Thus, it is preferred that the splitting of the split fibers 15A be completed prior to actual papermaking.

It should be noted that, in order to form the paper transporting felt 100 having optimal characteristics in correspondence with the type of paper to be made, the kinds of fibers for respectively forming the base layer 11, the batt layer 13, and the wet paper contacting fibrous layer 15 are selected, as required, by taking into account such as the respective characteristics or the characteristics when combined.

(Modification of the Paper Transporting Felt 100)

As a preferred modification of the paper transporting felt 100, it is possible to cite one which has a wet paper contacting fibrous layer formed by mixed-spun fibers containing 30 wt. % of the split fibers 15A of 1.9 dtex and the remainder (i.e., 70 wt. %) consisting of nonsplit fibers of 3.3 dtex. In this case, the average size of the fibers forming the wet paper contacting fibrous layer is approx. 2.9 dtex. It should be noted that the base layer 11 and the batt layer 13 are similar to the ones described above. Since the wet paper contacting fibrous layer contain nonsplit fibers which are not split into fine fibers, the surface of the wet paper contacting fibrous layer is prevented from becoming too dense, and appropriate water permeability is ensured, so that water can be effective squeezed from the wet paper W.

### Second Embodiment

Next, referring to FIG. 2, a description will be given of a paper transporting felt 200 for a shoe press in accordance with a second embodiment of the invention. It should be noted those constituent elements that are similar to those of the already described first embodiment (i.e., the paper transporting felt 100 for a shoe press) will be denoted by the same reference numerals or corresponding numerals in the drawing, and a description will be omitted or simplified.

As shown in FIG. 2, in the same way as the above-described paper transporting felt 100 for a shoe press the paper transporting felt 200 for a shoe press has the base layer 11, the batt layer 13 (the first batt layer 13A and the second batt layer 13B), and the wet paper contacting fibrous layer 15, but differs from the paper transporting felt 100 for a shoe press only in that the paper transporting felt 200 further has a hydrophilic nonwoven fabric 23 disposed in such a manner as to lie in the first batt layer 13A between the base layer 11 and the wet paper contacting fibrous layer 15.

More specifically, the second batt layer 13B is formed on the roll side surface or the shoe side surface of the base layer 11, and a first part 13Aa of the first batt layer 13A is formed on the wet paper side surface of the base layer 11. The hydrophilic nonwoven fabric layer 23 is formed on the wet paper side surface of the first part 13Aa of the first batt layer 13A, and a second part 13Ab of the first batt layer 13A is formed on the wet paper side surface of the hydrophilic nonwoven fabric layer 23. Further, the wet paper contacting fibrous layer 15 is formed on the wet paper side surface of the second part 13Ab of the first batt layer 13A so as to come into direct contact with the wet paper. These layers and parts are entangled and integrated by needling. The basis weight of the paper transporting felt 200 is 1350 g/m², the thickness of the paper transporting felt 200 is 3.4 mm, and the density of the entire fibers forming the paper transporting felt 200 is 0.397 g/m³. The basis weight of the hydrophilic nonwoven fabric layer 23 is 50 g/m², the thickness of the hydrophilic nonwoven fabric layer 23 is 0.1 mm, and the density of the fibers forming the hydrophilic nonwoven fabric layer 23 is 0.500 g/m³. It should be noted that, in the paper transporting felt 200, the density of the entire fibers in the plurality of layers excluding the wet paper contacting fibrous layer 15 is 0.379 g/m³ (the basis weight is 1100 g/m²). The air permeability of this paper transporting felt 200 thus constructed is 12.2 cc/cm²/sec (this value is a mean value of the values measured by applying a pressure of 125 Pa to test pieces of the paper transporting felt 200 in accordance with the Frazir method on the basis of JIS L 1096). It should be noted that the wet paper contacting fibrous layer 15 may be formed on the wet paper side surface of the hydrophilic nonwoven fabric layer 23 without forming the second part 13Ab of the first batt layer 13A.

The hydrophilic nonwoven fabric layer 23 is formed by a hydrophilic nonwoven fabric constructed with a high density by laminating non-split fibers which are finer than the fibers forming the batt layer 13 and which have, for example, a size of 4 dtex or smaller. As examples of the hydrophilic nonwoven fabric for forming the hydrophilic nonwoven fabric layer 23, it is possible to cite nonwoven fabrics formed by laminating fibers obtained by melting a resin such as nylon and by forming it into yarn, e.g., spunbonded nonwoven fabrics obtained by laminating continuous filaments, nonwoven fabrics obtained by drawing a molten polymer by hot air into ultra-fine fibers and forming them into sheet form, and so on.

To effectively prevent re-wetting, it is preferred that the hydrophilic property of the hydrophilic nonwoven fabric layer 23 be such that the angle of contact with water becomes 30° when the moisture percentage of the hydrophilic nonwoven fabric layer 23 is controlled so as to become 30 to 50%. It should be noted that the moisture percentage of the hydrophilic nonwoven fabric layer 23 is determined from (water/total weight)×100.

(Modification of the Paper Transporting Felt 200)

As a preferred modification of the paper transporting felt 200, it is possible to cite one in which the basis weight of the paper transporting felt is 1500 g/m², the thickness of the paper transporting felt is 4.0 mm, and the density of the entire fibers forming the paper transporting felt is 0.375 g/m³. Further, the basis weight of the base layer is 650 g/m², the thickness of the base layer is 1.7 mm, and the density of the fibers forming the base layer is 0.382 g/cm³. Further, the basis weight of the batt layer formed by the staple fibers 17 with a size of 3.3 dtex is 450 g/m² (more specifically, the basis weight of the first batt layer is 300 g/m², and the basis weight of the second batt layer is 150 g/m²). Still further, the thickness of the first batt layer is 0.8 mm, the density of the staple fibers 17 forming the first batt layer is 0.375 g/cm³, the thickness of the second batt layer is 0.6 mm, and the density of the staple fibers 17 forming the second batt layer is 0.250 g/cm³. Further, the basis weight of the wet paper contacting fibrous layer constituted by the split fibers 15A of 1.9 dtex is 350 g/m², the thickness of the wet paper contacting fibrous layer is 0.8 mm, and the density of the split fibers 15A forming the wet paper contacting fibrous layer is 0.438 g/m³. Furthermore, the basis weight of the hydrophilic nonwoven fabric layer is 50 g/m², the thickness of the hydrophilic nonwoven fabric layer is 0.1 mm, and the density of the fibers forming the hydrophilic nonwoven fabric layer is 0.500 g/m³. It should be noted that, in this modification of the paper transporting felt 200, the density of the entire fibers in the plurality of layers excluding the wet paper contacting fibrous layer is 0.359 g/m³. In addition, the air permeability of this modification of the paper transporting felt 200 is 10.8 cc/cm²/sec.

Next, referring to FIG. 4, a description will be given of a press apparatus 300 of the shoe press type paper machine in which are installed a pair of the paper transporting felts 100 for a shoe press and a pair of the paper transporting felts 200 for a shoe press each formed in the shape of an endless belt (annularly).

As shown in FIG. 4, the press apparatus 300 of the shoe press type paper machine is a so-called closed draw type press apparatus 300 in which two press mechanisms including a first press mechanism 51 and a second press mechanism 53 are disposed in series along a transporting direction of the wet paper W (the direction of arrow A). As the paper machine is constructed as the shoe press type paper machine of the closed draw type in which the wet paper W is transported and pressurized in the state of being sandwiched by the pair of the paper transporting felts 100 for a shoe press and the pair of the paper transporting felts 200 for a shoe press, the wet paper W can be transported stably at a high speed of, for instance, 1200 to 1400 m/min. Consequently, papermaking is made possible at an extremely high efficiency in comparison with the shoe press type paper machine of the open draw type and the like.

The first press mechanism 51 includes the pair of the paper transporting felts 100 for a shoe press, as well as a first shoe 55 and a first roll 57 (i.e., a first shoe press) which are disposed in face-to-face relation so as to form a first nip (i.e., a first pressing portion) therebetween. The second press mechanism 53 includes the pair of the paper transporting felts 200 for a shoe press, as well as a second shoe 59 and a second roll 61 (i.e., a second shoe press) which are disposed in face-to-face relation so as to form a second nip (i.e., a second pressing portion) therebetween.

It should be noted that although, as shown in FIG. 4, the paper transporting felt 100 may be adopted as the upper and lower paper transporting felts of the first press mechanism 51, the paper transporting felt 100 may alternatively be adopted as either one of the upper and lower paper transporting felts. In the case where the paper transporting felt 100 is installed as either one of the upper and lower paper transporting felts of the first press mechanism 51, it suffices if an arbitrary paper transporting felt is adopted in correspondence with the papermaking characteristics as the other one of the upper and lower paper transporting felts of the first press mechanism 51. Similarly, although, as shown in FIG. 4, the paper transporting felt 200 may be adopted as the upper and lower paper transporting felts of the second press mechanism 53, the paper transporting felt 200 may alternatively be adopted as either one of the upper and lower paper transporting felts. In the case where the paper transporting felt 200 is installed as either one of the upper and lower paper transporting felts of the second press mechanism 53, it suffices if an arbitrary paper transporting felt is adopted in correspondence with the papermaking characteristics as the other one of the upper and lower paper transporting felts of the second press mechanism 53. In addition, only the paper transporting felts 100 or only the paper transporting felts 200 may be adopted as the paper transporting felts of the first press mechanism 51 and the second press mechanism 53.

As the press apparatus 300 of the shoe press type paper machine is subjected to the so-called running-in operation, the split fibers 15A of the wet paper contacting fibrous layers 15 of the paper transporting felts 100 and the paper transporting felts 200 are split. Namely, the respective wet paper contacting fibrous layers 15 (i.e., the split fibers 15A) are pressurized when they pass between the first shoe 55 and the first roll 57 and between the second shoe 59 and the second roll 61, and are thereby formed into fine fibers by being split into seven parts including the petal portions 19 with sector-shaped sections and the stem portion 21 with a substantially asterisk-shaped section by the pressing action. Hence, the wet paper side surfaces of the paper transporting felts 100 and 200 become smooth surfaces. It should be noted that the condition of pressurization by the first shoe 55 and the first roll 57 with respect to the paper transporting felt 100 is 800 kN/m. In addition, the condition of pressurization by the second shoe 59 and the second roll 61 with respect to the paper transporting felt 200 is 1050 kN/m. Further, the shoe width is 10 inches for both the first shoe 55 and the second shoe 59, and the respective traveling speeds of the paper transporting felt 100 and the paper transporting felt 200 are 1700 m/min.

As shown in FIG. 4, the wet paper W carried out from a wire part (not shown) and delivered to the first press mechanism 51 is transported while being sandwiched by the pair of the paper transporting felts 100, and water is squeezed out by being pressurized by the first shoe 55 and the first roll 57. The squeezed water is absorbed by the paper transporting felts 100. Next, the wet paper W is delivered to the second press mechanism 53 and is transported while being sandwiched by the pair of the paper transporting felts 200, and water is further squeezed out by being pressurized by the second shoe 59 and the second roll 61. The squeezed water is absorbed by the paper transporting felts 200. At this time, as for the wet paper W, its surfaces coming into contact with the wet paper contacting fibrous layers 15 are made smooth, and the wet paper W is then delivered to a drier part (not shown) to dry.

It should be noted that when the pressure acting on the wet paper W and the paper transporting felts 200 in a zone extending from the second pressing portion formed by the second shoe 59 and the second roll 61 to the exit is released, the re-wetting phenomenon tends to occur in which the moisture in the paper transporting felts 200 is transferred to the wet paper W side. However, since the hydrophilic nonwoven fabric layer 23 is higher in density and lower in water permeability than the batt layer 13, the moisture in the second batt layer 13B disposed closer to the second shoe 59 side or the second roll 61 side than the hydrophilic nonwoven fabric layer 23 is difficult to permeate through the hydrophilic nonwoven fabric layer 23 and move to the first batt layer 13A on the wet paper W side. As a result, the occurrence of the re-wetting phenomenon is suppressed. In addition, since the size of the hydrophilic nonwoven fabric layer 23 is lower than the size of the batt layer 13, the moisture in the second part 13Ab of the first batt layer 13A disposed closer to the wet paper side than the hydrophilic nonwoven fabric layer 23 is transferred to the hydrophilic nonwoven fabric layer 23 by the capillary phenomenon and is held therein. Accordingly, the re-wetting phenomenon can be prevented effectively.

It should be noted that although, as described above, a description has been given of the press apparatus 300 having two-stage press mechanisms 51 and 53 by way of one example as an embodiment of the press apparatus of the shoe press type paper machine in accordance with the invention. However, it goes without saying that the press apparatus may be a press apparatus having one press mechanism or a press apparatus in which a multiplicity of press mechanisms are disposed in series.

Here, to deepen an understanding of the invention, a brief description will be given of the construction of the paper transporting felt for a shoe press in accordance with the invention and the construction of the embodiment of the press apparatus of the shoe press type paper machine having the paper transporting felt.

A paper transporting felt (100; 200) for a shoe press which is at least one paper transporting felt (100; 200) of a pair of paper transporting felts for a shoe press, which are disposed in a press apparatus 300 provided in a press part of a shoe press type paper machine, form a press mechanism (51; 53) together with a shoe press having a roll (57; 61) and a shoe (55; 59) in the press apparatus 300, and are pressurized by the roll (57; 61) and the shoe (55; 59) while sandwiching a wet paper W, to absorb water squeezed from the wet paper W.

The paper transporting felt (100; 200) for a shoe press has:

a base layer 11;

a first batt layer 13A which is formed on a wet paper W side surface of the base layer 11;

a second batt layer 13B which is formed on a roll (57; 61) side surface or a shoe (55; 59) side surface of the base layer 11; and

a wet paper contacting fibrous layer 15 which includes split fibers 15A and is formed on a wet paper W side surface of the first batt layer 13A so as to come into direct contact with the wet paper W,

wherein the split fibers 15A are split by being pressurized by the roll (57; 61) and the shoe (55; 59).

The wet paper contacting fibrous layer 15 may be formed by mixed-spun fibers containing 15 wt. % to 100 wt. % of the split fibers 15A and the remainder consisting of nonsplit fibers.

The press apparatus 300 of a shoe press type paper machine is a press apparatus of a shoe press type paper machine having a plurality of press mechanisms each having the paper transporting felt (100; 200) for a shoe press, wherein the plurality of press mechanisms 51, 53 are disposed in series along a transporting direction A of the wet paper W transported by the paper transporting felts 100, 200, and wherein at least one paper transporting felt 100 for a shoe press is disposed in the press mechanism 51 disposed on an upstream side in the transporting direction A among the plurality of press mechanisms 51, 53.

The paper transporting felt 200 for a shoe press further has: a hydrophilic nonwoven fabric layer 23 disposed between the base layer 11 and the wet paper contacting fibrous layer 15.

The press apparatus 300 of a shoe press type paper machine is a press apparatus of a shoe press type paper machine having a plurality of press mechanisms each having the paper transporting felt (100; 200) for a shoe press, wherein the plurality of press mechanisms 51, 53 are disposed in series along the transporting direction A of the wet paper W being transported by the paper transporting felts 100, 200, and
wherein at least one paper transporting felt 200 for a shoe press is disposed in the press mechanism 53 disposed on a downstream side in the transporting direction A among the plurality of press mechanisms 51, 53.

Each size of the split fibers 15A prior to splitting in the paper transporting felt (100; 200) for a shoe press is 3.3 dtex or smaller, more preferably 1.9 dtex.

The press apparatus 300 of a shoe press type paper machine is a press machine of a closed draw type.

As described above, according to the paper transporting felt (100; 200) for a shoe press, the wet paper contacting fibrous layer 15 including the split fibers 15A, which are formed into finer fibers by being split as the split fibers 15A are pressurized by the shoe press (i.e., the roll (57; 61) and the shoe (55; 59)), is formed on the wet paper W side surface of the first batt layer 13A of the paper transporting felt (100; 200) so as to come into direct contact with the wet paper W. Therefore, if the wet paper contacting fibrous layer 15 is formed which includes the split fibers 15A, which are formed into fine fibers of extremely small sizes by being split, it is possible to improve the surface smoothness of the wet paper W. Moreover, stains (specifically, components of such as additives and paste contained in the wet paper W) which are temporarily attached to the paper transporting felts (100; 200) fall off the paper transporting felts (100; 200) together with the fine fibers owing to the so-called phenomenon of loss of fibers of the fine fibers formed by the splitting of the split fibers 15A, and slight portions of them move to the wet paper W. Therefore, the stains are difficult to remain on the paper transporting felt (100; 200). At the time of this movement of stains, even if the fine fibers (i.e., the fine fibers formed by the splitting of the split fibers 15A) which fell off or cut off from the wet paper contacting fibrous layer 15 are more or less attached to the surface of the wet paper W, the quality of the wet paper W is not caused to decline since the fine fibers are extremely small. Moreover, since the stains which are moved to the wet paper W are originally contained in the wet paper W as its components, no effect is exerted on the quality of the wet paper W. Accordingly, as for the paper manufactured by the shoe press type paper machine using this paper transporting felt (100; 200) for a shoe press, its surface becomes extremely smooth. Moreover, since the life of the paper transporting felt (100; 200), i.e., the usable period of the paper transporting felt, is long, it is possible to decrease the frequency of maintenance for replacing the paper transporting felt (100; 200) with a new one. Accordingly, it is desirable that the split fibers 15A be included in at least the surface of the wet paper contacting fibrous layer 15 which comes into direct contact with the wet paper W.

In addition, according to the press apparatus 300 of a shoe press type paper machine, if the paper transporting felt 100 is disposed in the press mechanism 51 disposed on an upstream side in the transporting direction A of the wet paper W among the plurality of press mechanisms 51, 53, it is particularly suitable in effectively squeezing water from the wet paper W. Namely, according to the press apparatus 300 of a shoe press type paper machine having this construction, a large amount of water can be effectively squeezed from the wet paper W containing a large amount of water, with the result that high-speed papermaking operation becomes possible.

In addition, according to the paper transporting felt 200 for a shoe press, since the hydrophilic nonwoven fabric layer 23 is disposed between the base layer 11 and the wet paper contacting fibrous layer 15, the movement of the water temporarily absorbed from the wet paper W by the paper transporting felt 200 back to the wet paper W (i.e., the so-called re-wetting phenomenon) is prevented by the hydrophilic nonwoven fabric layer 23.

In addition, according to the press apparatus 300 of a shoe press type paper machine, if the paper transporting felt 200 for a shoe press is disposed in the press mechanism 53 disposed on the downstream side in the transporting direction A of the wet paper W among the plurality of press mechanisms 51, 53, it is conceivable that the water permeability may slightly decline as compared with the paper transporting felt 100. However, since the paper transporting felt 200 has not only a function of smoothing the wet paper surface but also a high re-wetting preventing function, this arrangement is particularly suitable in preventing the re-wetting phenomenon and suitable in smoothing the wet paper surface.

In addition, according to the paper transporting felt (100; 200) for a shoe press, since the size of each of the split fibers 15A prior to splitting is 3.3 dtex or smaller, even if the size of the split fiber 15A prior to splitting was 3.3 dtex, the size of the fine fibers formed by the splitting of the split fibers 15A becomes smaller than 3.3 dtex. Thus, if the wet paper contacting fibrous layer 15 including the slit fibers 15A, which become fine fibers of a size which is practically as close to the size of the fibers of the wet paper W as possible by being split, is formed, it is possible to manufacture high-quality paper extremely excelling in the surface smoothness. In addition, it is more preferable if the size of each of the split fibers prior to splitting is a small value of such as 1.9 dtex.

In addition, in the case where the wet paper contacting fibrous layer 15 is formed by mixed-spun fibers containing 15 wt. % to 100 wt. % of the split fibers 15A and the remainder consisting of nonsplit fibers, it is possible to change the characteristics of the paper transporting felt (100; 200) for a shoe press by appropriately changing the mix spinning ratio. Here, the weight ratio in mix spinning is defined by “weight of the split fibers 15A/(weight of the split fibers 15A+weight of the nonsplit fibers)×100.” The surface smoothness and the dewatering characteristic, which are the characteristics required for the paper transporting felt (100; 200) for a shoe press, are in an inversely proportional relationship. Hence, if the density of the paper transporting felt (100; 200) for a shoe press is increased to improve the performance of smoothing the surface of the wet paper W, the dewatering characteristic tends to deteriorate. Meanwhile, the plurality of press mechanisms 51, 53 disposed from the upstream side in the transporting direction of the wet paper W being transported to the downstream side respectively require subtly different functions. Priority is placed on the dewatering characteristic in the case of the paper transporting felt 100 of the press mechanism 51 disposed on the upstream side, while the performance of smoothing the surface of the wet paper W is required for the paper transporting felt 200 of the press mechanism 53 disposed on the downstream side. Accordingly, by appropriately changing the mix spinning ratio between the nonsplit fibers and the split fibers 15A, the paper transporting felts 100, 200 can be provided with optimal characteristics (surface smoothing characteristic, dewatering characteristic, etc.) for the respective press mechanisms 51, 53.

In addition, according to the press apparatus 300 of a shoe press type paper machine, since it is a press apparatus of a closed draw type, the wet paper W is transported in a state of being sandwiched by the pair of paper transporting felts (100; 200) for a shoe press. Consequently, the wet paper W can be transported at an extremely high speed without applying a force to the wet paper W which has weak strength and is likely to be cut off. Accordingly, efficient papermaking is made possible.

It should be noted that the splitting of the split fibers 15A of the wet paper contacting fibrous layer 15 of the paper transporting felt (100; 200) for a shoe press is preferably effected at the time of the trial operation (i.e., the so-called running-in operation) of the press apparatus 300 of a shoe press type paper machine. The split fibers 15A used in the paper transporting felt (100; 200) for a shoe press are preferably fibers which are split by being pressurized by the shoe press. The split fibers 15A are not split in the carding process and the needling process which are the processes of manufacturing the paper transporting felt, and the split fibers 15A maintain a relatively thick state. For example, if split fibers which are split into fine fibers at the time of carding are subjected to carding, fiber masses are likely to be produced. These fiber masses are implanted in the felt in the needling process, and form irregularities on the surface of the paper transporting felt, so that the surface smoothness of the wet paper declines. Accordingly, such a drawback can be overcome by using the wet paper contacting fibrous layer 15 including the split fibers 15A which are formed into finer fibers by being split as the split fibers 15a are pressurized by the shoe press.

It should be noted that the invention is not limited to the above-described embodiment and modifications, and alterations, improvements, and the like are possible, as required. In addition, the materials, shapes, numerical values, forms, numbers, places of disposition, and the like are arbitrary and are not limited, insofar as they are capable of attaining the invention.

For example, effective operation can be similarly obtained even if the paper transporting felt (100; 200) for a shoe press is installed in a shoe press type paper machine of an open draw type having a portion where the wet paper W is independently transported in the course of being transported.

This application is based upon and claims the benefit of priority from the prior Japanese Patent Applications No. 2004-233095 filed on Aug. 10, 2004, the entire contents of which are incorporated herein by reference.

1. A paper transporting felt for a shoe press, comprising:
a base layer;
a first batt layer which is formed on a wet paper side surface of the base layer;
a second batt layer which is formed on a roll side surface or a shoe side surface of the base layer; and
a wet paper contacting fibrous layer which includes split fibers and is formed on a wet paper side surface of the first batt layer so as to come into direct contact with the wet paper,
wherein the split fibers are split by being pressurized by the roll and the shoe.

2. The paper transporting felt for a shoe press according to claim 1,
wherein the wet paper contacting fibrous layer is formed by mixed-spun fibers containing 15 wt. % to 100 wt. % of the split fibers and the remainder consisting of nonsplit fibers.

3. The paper transporting felt for a shoe press according to claim 1, further comprising:
a hydrophilic nonwoven fabric layer disposed between the base layer and the wet paper contacting fibrous layer.

4. The paper transporting felt for a shoe press according to claim 1,
wherein each size of the split fibers prior to splitting is 3.3 dtex or smaller.

5. The paper transporting felt for a shoe press according to claim 4,
wherein each size of the split fibers prior to splitting is 1.9 dtex.

6. A press apparatus of a shoe press type paper machine comprising the paper transporting felt for a shoe press according to claim 1.

7. A press apparatus of a shoe press type paper machine comprising a plurality of press mechanisms each having the paper transporting felt for a shoe press according to claim 1,
wherein the plurality of press mechanisms are disposed in series along a transporting direction of the wet paper transported by the paper transporting felts.

8. The press apparatus of a shoe press type paper machine according to claim 7,
wherein the paper transporting felt for a shoe press according to claim 3 is disposed in the press mechanism disposed on a downstream side in the transporting direction among the plurality of press mechanisms.

9. The press apparatus of a shoe press type paper machine according to claim 7,
wherein each size of the split fibers prior to splitting is 3.3 dtex or smaller.

10. The press apparatus of a shoe press type paper machine according to claim 9,
wherein each size of the split fibers prior to splitting is 1.9 dtex.

11. The press apparatus of a shoe press type paper machine according to claim 6,
wherein the press apparatus is a press machine of a closed draw type.

12. The press apparatus of a shoe press type paper machine according to claim 7,
wherein the press apparatus is a press machine of a closed draw type.
